(19) United States
(12) Patent Application Publication
(10) Pub. No.: US 2015/0070942 A1
(43) Pub. Date: Mar. 12, 2015

(54) DC-DC CONVERTER

(71) Applicants: Sanken Electric Co., Ltd., Niiza-shi, Saitama (JP); National University Corporation Shimane University, Matsue-shi, Shimane (JP)

(72) Inventors: Hiromitsu Terui, Niiza-shi (JP); Hideki Asuke, Niiza-shi (JP); Hideharu Takano, Niiza-shi (JP); Masayoshi Yamamoto, Matsue-shi (JP); Jun Imaoka, Matsue-shi (JP)

(73) Assignees: Sanken Electric Co., Ltd., Niiza-shi, Saitama (JP); National University Corporation Shimane University, Matsue-shi, Shimane (JP)

(21) Appl. No.: 14/385,322

(22) PCT Filed: Jan. 24, 2013
(86) PCT No.: PCT/JP13/51475

§ 371 Date: Sep. 15, 2014

(30) Foreign Application Priority Data
Mar. 16, 2012 (JP) 2012-060547

(51) Int. Cl. H02M 3/335

(52) U.S. Cl. CPC H02M 3/33507
USPC 363/21.01

(57) ABSTRACT

A DC-DC converter includes a coupling transformer that has windings 11 and 12, switches (Tr1, Tr2) that are connected through the windings to both ends of a DC power source Vi, a series circuit that is connected to both ends of each of the switches and includes a diode and a smoothing capacitor, and a controller 100 that alternately turns on the switches Tr1 and Tr2 and simultaneously turns on the switches Tr1 and Tr2 for a predetermined overlapping period on every half cycle. The coupling transformer 1 includes an I-shaped core 4, two E-shaped cores 2 and 3 holding the I-shaped core 4 between them, and a gap 5 formed between each of center legs 2a and 3a of the E-shaped cores 2 and 3 and the I-shaped core 4. The windings 11 and 12 are wound around the I-shaped core 4.

### TECHNICAL FIELD

The present invention relates to a DC-DC converter for carrying out a step-up operation, and particularly, to the shape of a core used for a transformer.

### BACKGROUND ART

FIG. 1 is a circuit diagram illustrating a DC-DC converter according to a related art. FIG. 2 is an equivalent circuit diagram illustrating a coupling transformer 20 in the DC-DC converter of the related art illustrated in FIG. 1. The DC-DC converter illustrated in FIG. 1 has a DC power source Vi, the coupling transformer 20, switches Tr1 and Tr2, diodes D1 and D2, a smoothing capacitor Co, a load resistance Ro, and a controller 100.

The coupling transformer 20 has, as illustrated in FIG. 2, a transformer T3, a transformer T4, and a reactor L3. The transformer T3 has a primary winding 105a (having the number of turns of np), a coiled winding 105b (having the number of turns of np1) connected in series with the primary winding 105a, and a secondary winding 105c (having the number of turns of ns) electromagnetically coupled with the primary winding 105a and coiled winding 105b. The transformer T4 is configured same as the transformer T3 and has a primary winding 106a (having the number of turns of np), a coiled winding 106b (having the number of turns of np1) connected in series with the primary winding 106a, and a secondary winding 106c (having the number of turns of ns) electromagnetically coupled with the primary winding 106a and coiled winding 106b.

Both ends of the DC power source Vi are connected through the primary winding 105a of the transformer T3 to the collector and emitter of the switch Tr1 of an IGBT (Insulated Gate Bipolar Transistor). The both ends of the DC power source Vi are connected through the primary winding 106a of the transformer T4 to the collector and emitter of the switch Tr2 made of an IGBT. A connection point between the primary winding 105a of the transformer T3 and the collector of the switch Tr1, as well as the emitter of the switch Tr1 are connected to a series circuit that includes the coiled winding 105b of the transformer T3, the diode D1, and the smoothing capacitor Co. A connection point between the primary winding 106a of the transformer T4 and the collector of the switch Tr2, as well as the emitter of the switch Tr2 are connected to a series circuit that includes the coiled winding 106b of the transformer T4, the diode D2, and the smoothing capacitor Co.

Both ends of a series circuit that includes the secondary winding 105c of the transformer T3 and the secondary winding 106c of the transformer T4 are connected to the reactor L3. The controller 100 controls according to an output voltage Vo of the smoothing capacitor Co so that the switch Tr2 turns on after the switch Tr1 turns on and before the switch Tr1 turns off and so that the switch Tr1 turns on before the switch Tr2 turns off. Namely, it alternately turns on the switches Tr1 and Tr2 and makes the switches Tr1 and Tr2 simultaneously ON for a predetermined overlapping period on every half cycle.

According to the DC-DC converter of the related art having such a configuration, the controller 100 issues a control signal Tr1g to turn on the switch Tr1, and after the predetermined overlapping period, issues a control signal Tr2g to turn off the switch Tr2, so that a current passes through a path extending along Vi (plus (+) side), 105a, Tr1, and Vi (minus (−) side) to linearly increase the current of the switch Tr1. At the same time, the secondary winding 105c of the transformer T3 generates a voltage to pass a current L3i clockwise through a path extending along 105c, L3, 106c, and 105c.

The current L3i causes according to the law of equal ampere-turns of the transformer, to accumulate energy in the reactor L3 and the same current passes through the secondary winding 106c of the transformer T4. As a result, the primary winding 106a and coiled winding 106b of the transformer T4 induce voltages depending on the numbers of turns thereof.

When the transformer T4 has a turn ratio A as expressed by A=(np+np1)/np, a current of “1/A” of the current to the switch Tr1 passes to the diode D2 through a route extending along Vi+, 106a, 106b, D2, Co, and Vi−. The current passes through the diode D2 until the switch Tr2 turns on. The output voltage Vo of the smoothing capacitor Co is the sum of a voltage generated by the primary winding 106a of the transformer T4 and a voltage generated by the coiled winding 106b of the transformer T4.

A voltage generated on the transformer T4 is expressed by a relationship of A×Vi×D, where D is an ON-duty of the switch Tr1 (D=Ton/T) and T is a switching period of the switch Tr1. The output voltage Vo of the smoothing capacitor Co is expressed by Vo=Vi (1+A×D). Accordingly, managing the ON-duty D results in controlling the output voltage Vo.

Thereafter, the controller 100 issues a control signal Tr2g to turn on the switch Tr2, and after the predetermined overlapping period, issues a control signal Tr1g to turn off the switch Tr1. This results in causing a current passing through a path extending along Vi+, 106a, Tr2, and Vi−, to linearly increase a current to the switch Tr2. At the same time, the secondary winding 106c of the transformer T4 generates a voltage to increase and pass the current L3i clockwise through a path extending along 106c, 105c, L3, and 106c.

The current L3i causes according to the law of equal ampere-turns of the transformer, to accumulate energy in the reactor L3 and the same current passes through the secondary winding 105c of the transformer T3. As a result, the primary winding 105a and coiled winding 105b of the transformer T3 induce voltages depending on the numbers of turns thereof.

When the transformer T3 has a turn ratio A as defined by A=(np+np1)/np, a current having a value of the current of the switch Tr2 divided by A passes through a path extending along Vi+, 105a, 105b, D1, Co, and Vi−. The current to the diode D1 passes until the switch Tr1 turns on. The output voltage Vo of the smoothing capacitor Co is the sum of a voltage (an input voltage) of the DC power source Vi, a voltage generated by the primary winding 105a of the transformer T3, and a voltage generated by the coiled winding 105b of the transformer T3. A voltage generated on the transformer T3 is expressed by A×Vi×D, where D is an ON-duty of the switch Tr2 (D=Ton/T), and T is a switching period of the switch Tr2. The output voltage Vo of the smoothing capacitor Co is expressed by Vo=Vi (1+A×D). Accordingly, managing the ON-duty D results in controlling the output voltage Vo.

The DC-DC converter of the related art illustrated in FIG. 1 is known as a multiphase transformer-linked step-up chopper circuit whose example is disclosed in Japanese Unexamined Patent Application Publication No. 2010-004704 (Patent Literature 1) (refer to Patent Literature 1). The DC-DC converter connects two independent phases to each other through a transformer. This reduces the number of required cores from two to one to carry out a step-up operation.

The coupling transformer 20 has a core 21 that is a combination of two E-shaped core members faced in an extending planar direction. The core 21 has side legs 22 and 23, a center leg 24, and a gap 25. Around the side leg 22, a winding 31 is wound, and around the side leg 23, a winding 32 is wound. A current i1 passes through the winding 31 and a current i2 the winding 32.

### SUMMARY OF INVENTION

### Problems to be Solved by Invention

The coupling transformer 20, however, leaks a magnetic flux component φ1k (φ is a Greek letter “phi”) outside the windings 31 and 32 as illustrated in FIG. 3. Also, the gap 25 of the core 21 leaks a magnetic flux component φfr due to a fringing effect. Namely, the coupling transformer 20 of the related art causes large leakage flux to enlarge differences from theoretical values.

The present invention is able to provide a DC-DC converter having a coupling transformer that substantially realizes a design based on theoretical values.

### Means to Solve Problems

According to a technical aspect of the present invention, the DC-DC converter includes a coupling transformer having a first winding and a second winding, a first switch connected through the first winding to both ends of a DC power source, a second switch connected through the second winding to the both ends of the DC power source, a first series circuit connected to both ends of the first switch and including a first diode and a smoothing capacitor, a second series circuit connected to both ends of the second switch and including a second diode and the smoothing capacitor, and a controller that alternately turns on the first and second switches and simultaneously turns on the first and second switches for a predetermined overlapping period on every half cycle. The coupling transformer has an I-shaped core, two E-shaped cores holding the I-shaped core between them, a first gap formed between a center leg of one of the E-shaped cores and the I-shaped core, a second gap formed between a center leg of the other E-shaped core and the I-shaped core, and the first and second windings wound around the I-shaped core.

### BRIEF DESCRIPTION OF DRAWINGS

FIG. 1 is a circuit diagram illustrating a DC-DC converter according to a related art.

FIG. 2 is an equivalent circuit diagram illustrating a coupling transformer in the DC-DC converter of the related art illustrated in FIG. 1.

FIG. 3 is a view explaining the cause of a gap length increase in the DC-DC converter of the related art illustrated in FIG. 1.

FIG. 4 is a circuit diagram illustrating a DC-DC converter according to Embodiment 1.

FIG. 5 is a schematic view illustrating a coupling transformer with an EEI core in the DC-DC converter according to Embodiment 1.

FIG. 6 is a comparative view illustrating a gap length of the related art and that of Embodiment 1.

FIG. 7 is a comparative view illustrating a winding method of the coupling transformer of the related art and that of Embodiment 2.

### MODE OF IMPLEMENTING INVENTION

DC-DC converters according to embodiments of the present invention will be explained in detail with reference to the drawings.

The DC-DC converters of the present invention are characterized in that each employs two E-shaped cores and an I-shaped core to realize a coupling transformer that reduces leakage flux and substantially realizes a design based on theoretical values.

### Embodiment 1

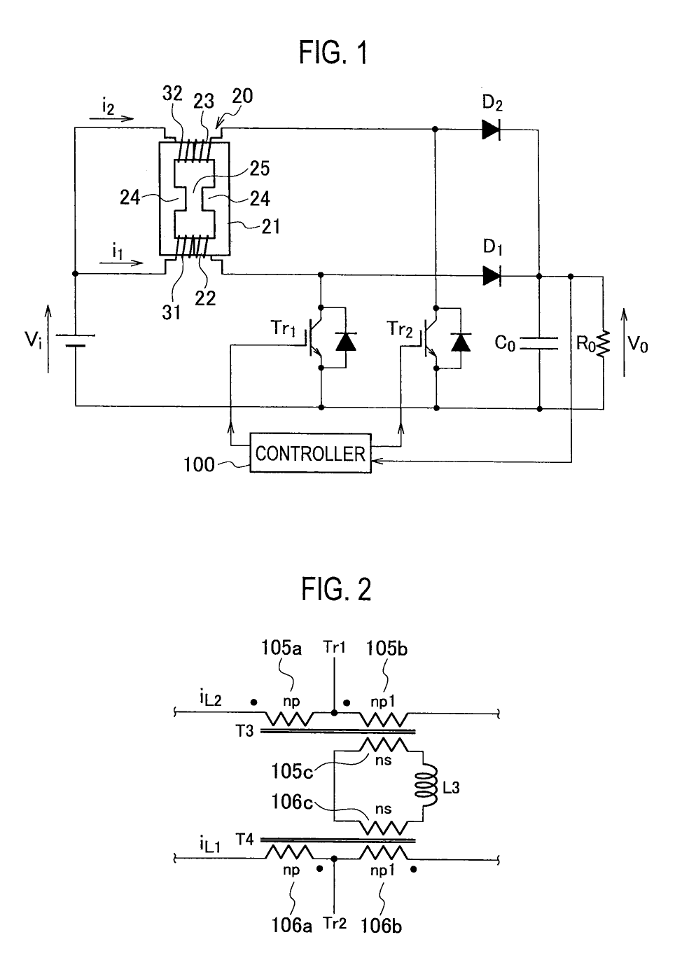

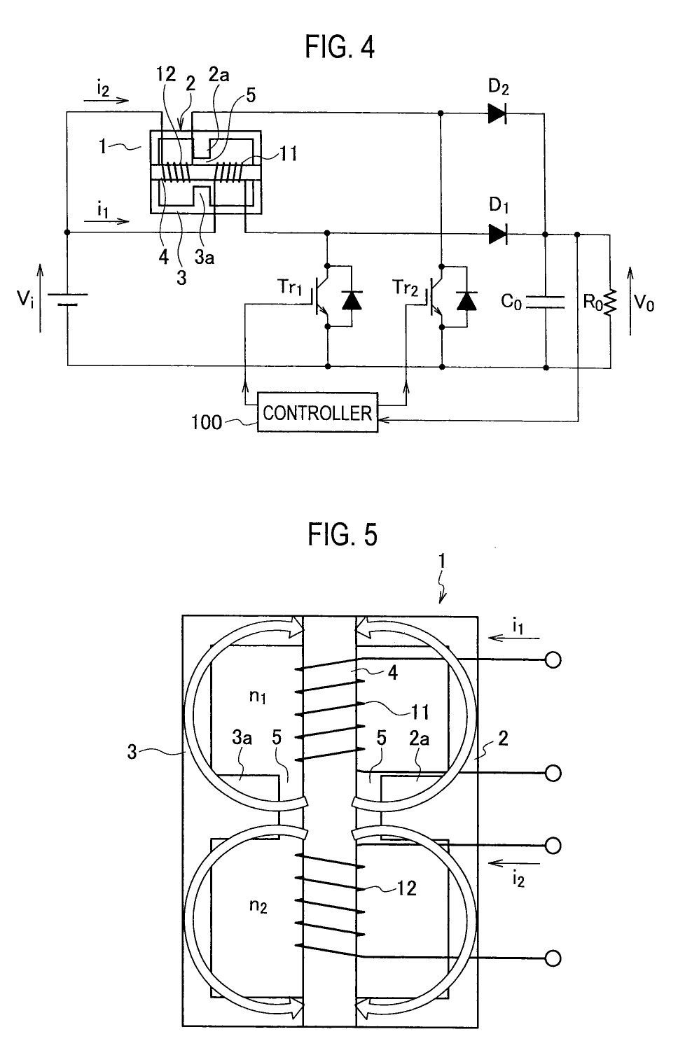

FIG. 4 is a circuit diagram illustrating a DC-DC converter according to Embodiment 1. FIG. 5 is a schematic view illustrating a coupling transformer that employs an EEI core and is incorporated in the DC-DC converter of Embodiment 1. The embodiment is characterized in that it employs, instead of the coupling transformer 20 of the related art illustrated in FIGS. 1 to 3, the coupling transformer 1 illustrated in FIG. 5.

The remaining configuration of FIG. 4 is the same as that of FIG. 1, and therefore, like parts are represented with like reference marks to omit the detailed explanations thereof. Only the coupling transformer 1 will be explained here.

The coupling transformer 1 illustrated in FIG. 5 has an I-shaped core 4 and two E-shaped cores 2 and 3 that hold the I-shaped core 4 between them. The two E-shaped cores 2 and 3 are integrated into one so that center legs 2a and 3a thereof face each other in an extending planar direction with the I-shaped core 4 interposed between them. More precisely, a first gap 5 is formed between the center leg 2a of the E-shaped core 2 and the I-shaped core 4 and a second gap 5 is formed between the center leg 3a of the E-shaped core 3 and the I-shaped core 4. Around the I-shaped core 4, a winding 11 (a first winding) having the number of turns of n1 and a winding 12 (a second winding) having the number of turns of n2 are wound. A current i1 passes through the winding 11 and a current i2 passes through the winding 12. As a result, as illustrated in FIG. 5, the inside of the integrated cores 3 and 4 forms four stable closed magnetic paths.

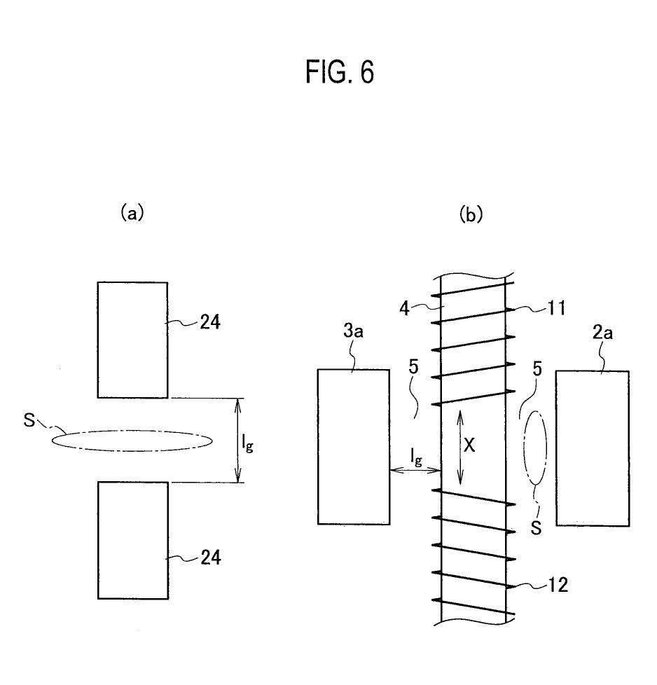

FIG. 6 is a comparative view illustrating a gap length of the related art and that of Embodiment 1, in which FIG. 6(a) is of the related art and FIG. 6(b) of Embodiment 1. A theoretical magnetic resistance value Rmg of a gap is expressed with the following expression:

Rmg=1 g/μo×S,
where 1 g is a gap length, S is a sectional area, and μo is a magnetic permeability.

According to the coupling transformer 1 of the embodiment with such a configuration, the current it passes through the winding 11 and the current i2 passes through the winding 12. As illustrated in FIG. 5, the currents passing through the windings 11 and 12 generate magnetic flux along magnetic paths starting from the I-shaped core 4, passing through the gaps 5 and E-shaped cores 2 and 3, and returning to the I-shaped core 4. Closed magnetic paths are formed to greatly reduce leakage magnetic flux and shorten a gap length.

In this way, the embodiment is able to provide a DC-DC converter having the coupling transformer that is capable of substantially realizing a design based on theoretical values.

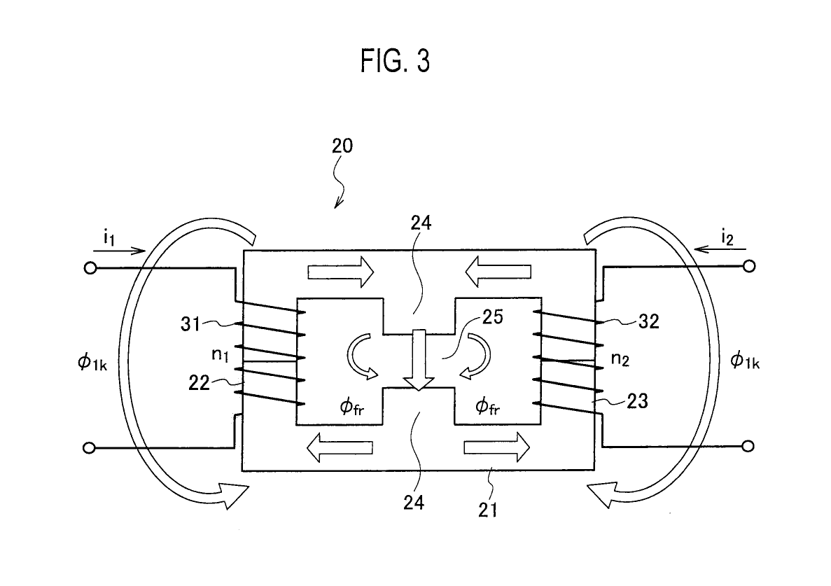

On the other hand, the coupling transformer 20 of the related art illustrated in FIG. 3 winds the windings 31 and 32 around the side legs 22 and 23, and therefore, magnetic flux leaks outside the side legs 22 and 23. This results in increasing leakage magnetic flux and expanding a difference between an actually measured value and a theoretical value.

### Embodiment 2

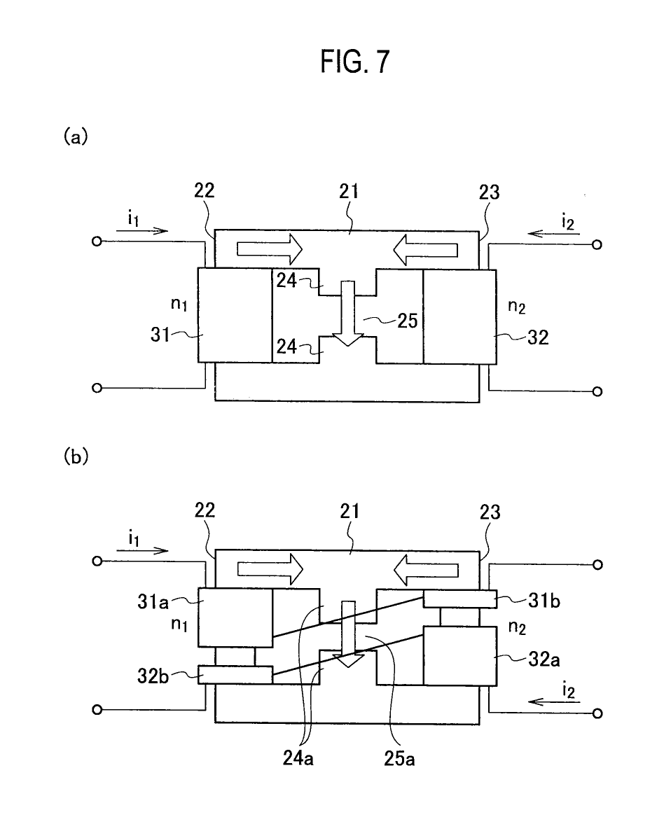

FIG. 7 is a comparative view illustrating a winding method of the coupling transformer according to the related art and that according to Embodiment 2, in which FIG. 7(a) is a schematic view of the coupling transformer 20 according to the related art and FIG. 7(b) is of a coupling transformer according to Embodiment 2.

Except for the coupling transformer, the DC-DC converter of Embodiment 2 is the same as that illustrated in FIG. 4.

According to the coupling transformer 20 of the related art illustrated in FIG. 7(a), the winding 31 having the number of turns of n1 is wound around the side leg 22 and the winding 32 having the number of turns of n2 is wound around the side leg 23.

On the other hand, the coupling transformer of the embodiment illustrated in FIG. 7(b) connects, between a positive electrode of a DC power source Vi and the collector of a switch Tr1, a series circuit in which a winding 31a (a first winding) is connected in series with a winding 31b (a second winding). A winding 32a (a third winding) is connected in series with a winding 32b (a fourth winding) and this series circuit is connected between the positive electrode of the DC power source Vi and the collector of a switch Tr2.

The coupling transformer has two E-shaped cores that are integrated into a θ-shape with respective center legs 24a being faced to each other in an extending planar direction. A gap 25a is formed between the center leg 24a of one of the E-shaped cores and the center leg 24a of the other E-shaped core. Around side legs 22 of the E-shaped cores, the windings 31a and 32b are wound, and around side legs 23 of the E-shaped cores, the windings 31b and 32a are wound.

The sum of the numbers of turns of the windings 31a and 31b is n1 and the sum of the numbers of turns of the windings 32a and 32b is n2.

Namely, windings 31 and 32 are each divided into two and the windings 31a and 32b are wound around the side legs 22 and the windings 31b and 32a around the side legs 23. As results, magnetomotive force is distributed and a gap length is shortened, thereby the degree of coupling is improved.

In this way, the present invention is able to provide a DC-DC converter having the coupling transformer that is capable of reducing leakage magnetic flux and substantially realizing a design based on theoretical values.

### (United States Designation)

In connection with United States designation, this international patent application claims the benefit of priority under 35 U.S.C. 119(a) to Japanese Patent Application No. 2012-060547 filed on Mar. 16, 2012 whose disclosed contents are cited herein.

1. A DC-DC converter comprising:
a coupling transformer having a first winding and a second winding;
a first switch connected through the first winding to both ends of a DC power source;
a second switch connected through the second winding to the both ends of the DC power source;
a first series circuit connected to both ends of the first switch and including a first diode and a smoothing capacitor;
a second series circuit connected to both ends of the second switch and including a second diode and the smoothing capacitor; and
a controller alternately turning on the first and second switches and simultaneously turning on the first and second switches for a predetermined overlapping period on every half cycle, wherein
the coupling transformer has an I-shaped core and two E-shaped cores that hold the I-shaped core therebetween;
a first gap is formed between a center leg of one of the E-shaped cores and the I-shaped core;
a second gap is formed between a center leg of the other E-shaped core and the I-shaped core; and
the first and second windings are wound around the I-shaped core.

2. A DC-DC converter comprising:
a coupling transformer having a first winding, a second winding connected in series with the first winding, a third winding, and a fourth winding connected in series with the third winding;
a first switch connected through the first and second windings to both ends of a DC power source;
a second switch connected through the third and fourth windings to the both ends of the DC power source;
a first series circuit connected to both ends of the first switch and including a first diode and a smoothing capacitor;
a second series circuit connected to both ends of the second switch and including a second diode and the smoothing capacitor; and
a controller alternately turning on the first and second switches and simultaneously turning on the first and second switches for a predetermined overlapping period on every half cycle, wherein:
the coupling transformer has two E-shaped cores that are combined together with their center legs being faced to each other;
a gap is formed between the center legs of the E-shaped cores;
the first and fourth windings are wound around first side legs of the E-shaped cores; and
the second and third windings are wound around second side legs of the E-shaped cores.
